(19) United States
(12) Patent Application Publication
(10) Pub. No.: US 2019/0049792 A1
(43) Pub. Date: Feb. 14, 2019

(54) LIGHT SOURCE COMPONENT, BACKLIGHT MODULE AND LIQUID CRYSTAL DISPLAY

(71) Applicant: Shenzhen China Star Optoelectronics Technology Co. Ltd., Shenzhen, Guangdong (CN)

(72) Inventors: Sheng-Jer Chang Chien, Shenzhen, Guangdong (CN); Yong Fan, Shenzhen, Guangdong (CN); Yuchun Hsiao, Shenzhen, Guangdong (CN)

(21) Appl. No.: 15/570,890

(22) PCT Filed: Jul. 25, 2017
(86) PCT No.: PCT/CN2017/094365

§ 371 Date: Oct. 31, 2017

(30) Foreign Application Priority Data
Jul. 4, 2017 (CN) 201710539458.8

(51) Int. Cl. G02F 1/1335

(52) U.S. Cl. CPC G02F 1/133603; G02F 1/133606; G02F 1/133605; G02F 1/133615

(57) ABSTRACT

The present disclosure provides a light source component, which includes a power supply plate; at least two point light sources disposed on the power supply plate; and a reflective block disposed on the power supply plate and between two point light sources adjacent to each other, wherein the reflective block is used to reflect light emitted from the point light sources thereto along a direction away from the power supply plate. The present disclosure further provides a backlight module and a liquid crystal display with the light source component. The present disclosure can reduce the amount of the point light source used and save the cost significantly when manufacturing point light sources of the same number by disposing a reflective block which serves equivalently as a point light source between the point light sources.

### TECHNICAL FIELD

The present disclosure relates to a liquid crystal display technical field, and particularly, to a light source component, a back light module and a liquid crystal display.

### BACKGROUND ART

With the development of information society, people's demand for flat panel displays has grown rapidly. The liquid crystal display (LCD for short) has characteristics of small volume, low power consumption, no radiation, and the like, and thus is dominated in the current flat panel display market.

Currently, the liquid crystal displays are mainly divided into direct liquid crystal display and edge liquid crystal display depending on the difference of the light incident mode. In the traditional direct liquid crystal display, the LED applied has only one light exit surface (i.e., top light exit surface). The light control area is very narrow without secondary lens, and thus all the LEDs in the traditional direct liquid crystal display have secondary lenses to expand the light control area to reduce the number of lights and the cost. However, the cost of lens and lens supporters will be increased with the addition of the secondary lens, and the light control area is approximately a circle rather than a rectangle.

Nowadays, in a thin large size liquid crystal display, HDR (High Dynamic Ratio) becomes an important index to measure an upmarket liquid crystal display. For the HDR liquid crystal display, the more the backlight partitions, the closer the light control area of single backlight partition is to a square, and the better the HDR. However, as mentioned above, since the light control area formed is approximate a circle after the existing LED had been coupled with secondary lens, the HDR will be affected. To solve this problem, four-side light emitting LEDs are usually used, and the light control areas thereof are squares, which can effectively promote the HDR. However, the four-side light emitting LEDs are expensive, and thus how to reduce the number of the four-side light emitting LEDs becomes a technical problem needed to be solved.

### SUMMARY

To solve the above problems in the prior art, the present disclosure aims at providing a light source component, a backlight module and a liquid crystal display, all of which are capable of reducing the number of the four-side light emitting LEDs used.

According to one aspect of the present disclosure, a light source component is provided, comprising: a power supply plate; at least two point light sources disposed on the power supply plate; a reflective block disposed on the power supply plate and between two point light sources adjacent to each other, wherein the reflective block is used to reflect light emitted from the point light sources thereto along a direction away from the power supply plate.

Alternatively, the reflective block has a curved surface concaved toward the point light sources.

Alternatively, the cross-sectional shape of the reflective block is a triangle-like shape, and the edges of the triangle-like shape facing towards the point light sources are concave curved edges.

Alternatively, the point light sources are cuboid-shaped LED lights, and light is emitted from four sides of the LED lights.

Alternatively, the reflective block is formed of polycarbonate, polyamide or polyphthalamide.

According to another aspect of the present disclosure, a backlight module is provided, comprising: the light source component of any one of claims 1-5; an optical plate disposed opposite to the power supply plate, wherein the surface of the power supply plate mounted with the point light sources faces the optical plate, and the reflective block is used to reflect light emitted from the point light sources thereto to the optical plate.

Alternatively, the backlight module further comprises: a reflective sheet disposed between the power supply plate and the point light sources and the reflective block.

Alternatively, the number of the point light sources and the number of the reflective blocks are the same, and the point light sources and the reflective blocks are arranged in an array, and are disposed alternatively in row and column directions of the array.

According to yet one aspect of the present disclosure, a liquid crystal display is provided, comprising the above backlight module and a liquid crystal panel facing each other.

The advantageous effects of the present disclosure: by disposing a reflective block which is equivalent to a point light source between the point light sources, the number of the point light sources can be reduced when manufacturing point light sources of the same number, therefore the cost can be saved significantly.

### BRIEF DESCRIPTION OF THE DRAWINGS

The above and other aspects, characteristics and advantages of the present disclosure will become more apparent from the following description with reference to the accompanying drawings, in which:

FIG. 1 is a structural schematic diagram of a light source component according to an embodiment of the present disclosure;

FIG. 2 is a structural schematic diagram of a backlight module according to an embodiment of the present disclosure;

FIG. 3 is a top view of a light source component in the backlight module according to an embodiment of the present disclosure; and

FIG. 4 is a structural schematic diagram of a liquid crystal display according to an embodiment of the present disclosure.

### DETAILED DESCRIPTION OF THE EXEMPLARY EMBODIMENTS

Embodiments of the present disclosure will be described in detail with reference to the drawings below. However, the present disclosure may be implemented in many different ways, and should not be interpreted as limited to the specific embodiments described herein. On the contrary, these examples are provided to explain the principle and practical application of the present disclosure, so that those skilled in the art can understand various embodiments of the present disclosure and various changes suitable for specifically-expected applications.

In the drawings, the thickness of layers and areas are exaggerated for clarity. Like reference numerals may refer to like elements throughout the specification and drawings.

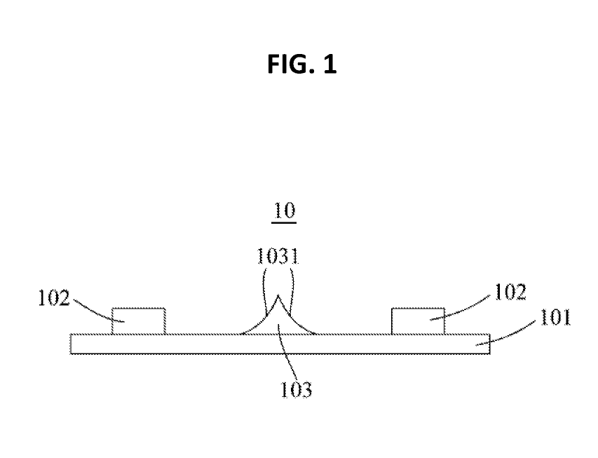

FIG. 1 is a structural schematic diagram of a light source component according to an embodiment of the present disclosure.

Referring to FIG. 1, the light source component 10 according to an embodiment of the present disclosure comprises: a power supply plate 101, two point light sources 102, and one reflective block 103.

The power supply plate 101 may be, for example, a print circuit board, however, the present disclosure is not limited thereto. The two point light sources 102 are disposed on the power supply plate 101 at intervals, so that the power supply plate 101 can supply electrical power to the two light sources 102. The reflective block 103 is disposed between the two point light sources 102, and capable of reflecting light emitted from the point light sources 102 thereto along the direction away from the power supply plate 101. That is to say, the reflective plate 103 at this time is equivalent to a point light source 102.

In the present disclosure, the number of the point light sources 102 is not limited to two, and can be set to any number according to actual need. Similarly, in the present disclosure, the number of the reflective block 103 is not limited to one, and is set in accordance with the number of the point light sources 102, and the setting of the number should satisfy that one reflective block 103 is disposed between two point light sources 102 adjacent to each other.

As an exemplary embodiment, the reflective block 103 has concave curved surfaces 1031 towards the point light sources 102. Further, as an exemplary embodiment, the cross-sectional shape of the reflective block 103 is a triangle-like shape, and the edges of the triangle-like shape towards the point light sources 102 are concave curved edges. Certainly, the reflective block of the present disclosure may have other structures, as long as it can reflect the light emitted from the point light source 102 thereto along the direction away from the power supply plate 101, and, for example, the cross-sectional shape of the reflective block 103 is a triangle.

In addition, the reflective block 103 may be formed of polycarbonate, polyamide, polyphthalamide or other white resin materials with high reflectivity, but the present disclosure is not limited thereto.

In the present embodiment, the point light sources 102 are cuboid-shaped LED lights, and light is emitted from four sides of the LED lights. It should be stated that the point light sources of the present disclosure is not limited to the point light sources described herein.

Accordingly, in the light source component 10 of the present disclosure, by setting a reflective block 103 which serves as a point light source between the two light sources 102, the number of the light sources can be reduced in the case that the same number of point light sources are made, and thus the cost is greatly saved.

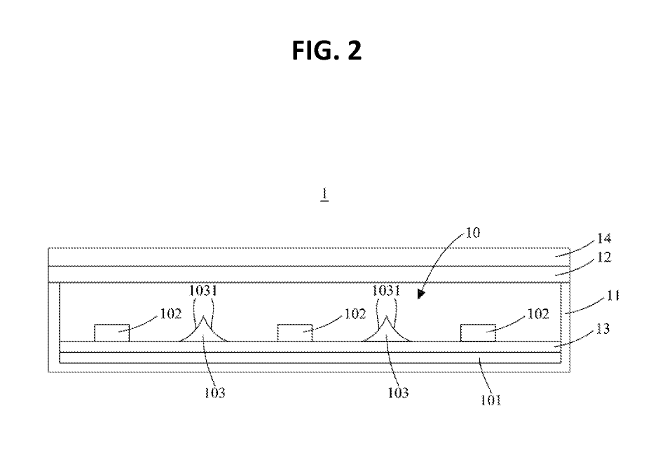

FIG. 2 is a structural schematic diagram of a backlight module according to an embodiment of the present disclosure.

Referring to FIG. 2, the backlight module 1 according to an embodiment of the present disclosure comprises: the light source component 10, a back frame 11, an optical plate 12, a reflective sheet 13 and an optical film 14.

The light source component 10 is disposed in the back frame 11, and the optical plate 12 is disposed on the back frame 11, so that the surface of the power supply plate 101 of the light source component 10 mounted with the point light sources 102 and the reflective block 103 faces the optical plate 12. In this way, the reflective block 103 reflects light emitted from each point light source 102 thereto to the optical plate 12, and the optical film 14 is disposed on the optical plate 12.

The optical plate 12 may be, for example, a diffuser plate, but the present disclosure is not limited thereto. The number of the optical film 14 is not limited to one as shown in FIG. 2, but can be set to any number in accordance with actual need, and the optical film can be set according to the actually demanded function. For example, the optical film 14 may be bright enhancement film, diffuser film, and the like.

The reflective plate 13 is disposed on the surface of the power supply plate 101 mounted with the point light sources 102 and the reflective plate 103. The reflective plate 13 is used to reflect light emitted from the point light sources 102 and the reflective block 103 thereto to the optical plate 12, so as to improve the utilization of light. Accordingly, it is a prefer embodiment to set the reflective plate 103, as another embodiment of the present disclosure, the reflective plate 103 may be omitted.

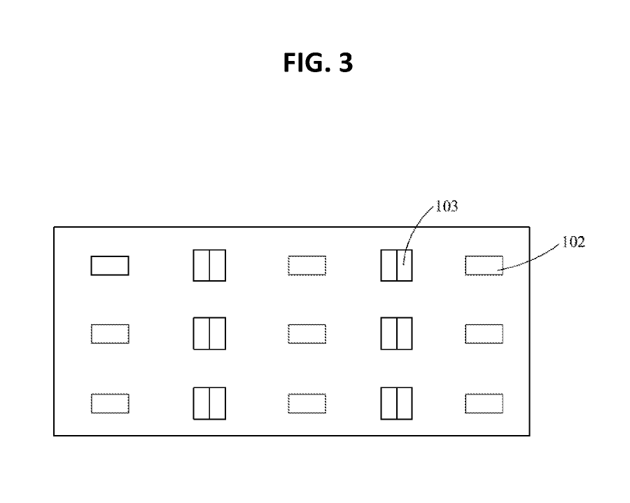

In the backlight module 1 of the present embodiment, the number of the point light sources 102 and the reflective blocks 103 are increased according to actual needs. FIG. 3 is a top view of a light source component in the backlight module according to an embodiment of the present disclosure. In FIG. 3, as an example, the point light source 102 is represent by a box, and the reflective block 103 is represent by a box with a vertical line. Referring to FIG. 3, preferably, the number of the point light sources 102 and the number of the reflective blocks 103 are the same. The point light sources 102 and the reflective blocks 103 are arranged in an array together, and are alternatively disposed in row and column directions. Herein, the numbers and arrangements of the light sources and the reflective blocks are a preferable embodiment. As another embodiment of the present disclosure, a plurality of point light sources 102 are arranged in an array, and at least one of the plurality of the point light sources 102 arranged in the array is replaced with the reflective block 103.

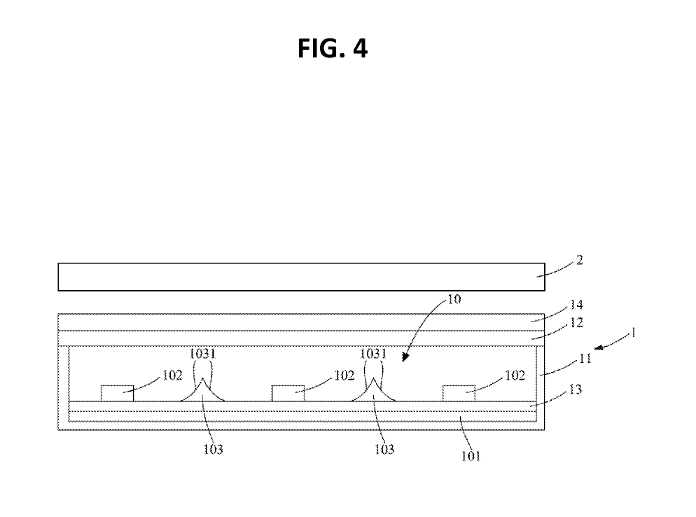

FIG. 4 is a structural schematic diagram of a liquid crystal display according to an embodiment of the present disclosure.

Referring to FIG. 4, the liquid crystal display according to an embodiment of the present disclosure comprises: a backlight module 1 and a liquid crystal panel 2. The backlight module 1 faces with the liquid crystal panel 2, and the back light module 1 provides uniform area display light to the liquid crystal panel 2, thereby the liquid crystal panel 2 displays images by the uniform area display light.

Accordingly, according to the embodiments of the present disclosure, by using a reflective block which serves equivalently as a point light source to replace the point light source, the amount of the point light sources to be used can be reduced, and thus the cost can be saved.

Although the present disclosure has been shown and described with reference to specific embodiments, those skilled in the art will understand that various changes in forms and details may be made herein without departing from the spirit and scope of the present disclosure as defined by the appended claims and the equivalents thereof.

1. A light source component comprising:
a power supply plate;
at least two point light sources disposed on the power supply plate; and
a reflective block disposed on the power supply plate and between two point light sources adjacent to each other,
wherein the reflective block is used to reflect light emitted from the point light sources thereto along a direction away from the power supply plate.

2. The light source component of claim 1, wherein, the reflective block has a curved surface concaved toward the point light sources.

3. The light source component of claim 2, wherein, the cross-sectional shape of the reflective block is a triangle-like shape, and the edges of the triangle-like shape towards the point light sources are concave curved edges.

4. The light source component of claim 1, wherein the point light sources are cuboid-shaped LED lights, and light is emitted from four sides of the LED lights.

5. The light source component of claim 1, wherein, the reflective block is formed of polycarbonate, polyamide or polyphthalamide.

6. A backlight module comprising:
a light source component, which comprises a power supply plate, at least two point light sources disposed on the power supply plate, and a reflective block disposed on the power supply plate and between two point light sources adjacent to each other, wherein the reflective block is used to reflect light emitted from the point light sources thereto along a direction away from the power supply plate; and
an optical plate disposed opposite to the power supply plate,
wherein the surface of the power supply plate mounted with the point light sources faces the optical plate, and the reflective block is used to reflect light emitted from the point light sources thereto to the optical plate.

7. The backlight module of claim 6, wherein, the backlight module further comprises a reflective sheet disposed between the power supply plate and the point light sources and the reflective block.

8. The backlight module of claim 6, wherein, the number of the point light sources and the number of the reflective blocks are the same, and the point light sources and the reflective blocks are arranged in an array, and are disposed alternatively in row and column directions of the array.

9. The backlight module of claim 7, wherein, the number of the point light sources and the number of the reflective blocks are the same, and the point light sources and the reflective blocks are arranged in an array, and are disposed alternatively in row and column directions of the array.

10. The backlight module of claim 6, wherein, the reflective block has a curved surface concaved toward the point light sources.

11. The backlight module of claim 10, wherein, the cross-sectional shape of the reflective block is a triangle-like shape, and the edges of the triangle-like shape facing towards the point light sources are concave curved edges.

12. The backlight module of claim 6, wherein the point light sources are cuboid-shaped LED lights, and light is emitted from four sides of the LED lights.

13. The backlight module of claim 6, wherein, the reflective block is formed of polycarbonate, polyamide or polyphthalamide.

14. A liquid crystal display comprising a backlight module and a liquid crystal panel facing each other, wherein, the backlight module is the backlight module of claim 6.
